(19) United States
(12) Patent Application Publication
(10) Pub. No.: US 2009/0174717 A1
(43) Pub. Date: Jul. 9, 2009

(54) METHOD AND APPARATUS FOR GENERATING A STORYBOARD THEME FOR BACKGROUND IMAGE AND VIDEO PRESENTATION

(75) Inventors: JOHN SALISBURY, Carlsbad, CA (US); MONISH SUBHERWAL, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: Sony Corporation, Tokyo (JP); Sony Electronics, Inc., Park Ridge, NJ (US)

(21) Appl. No.: 12/113,815

(22) Filed: May 1, 2008

Related U.S. Application Data
(60) Provisional application No. 61/019,368, filed on Jan. 7, 2008.

(51) Int. Cl. G06T 13/00

(52) U.S. Cl. 345/473

(57) ABSTRACT

A method and apparatus for using a non-active (background) state of a display-enabled device to animate images and video elements within a themed storyboard from selected sources. States described in the method include: tuning to select viewable content, population of the storyboard matrix, animation of storyboard elements using animation effects, such as lens flare and live video texturing, and evaporation of the elements. By way of example, the storyboard is populated with freeze frames of video content, one or a portion of which are then played to animate that element. The storyboard preferably cycles with additional content as the prior content evaporates, until the background mode is terminated. The method is particularly well-suited for use in television sets, although it can be integrated into any display-enable apparatus having a computer and access to content sources that can be used for storyboard elements.

### CROSS-REFERENCE TO RELATED APPLICATIONS

This application claims priority from U.S. provisional patent application Ser. No. 61/019,368 filed on Jan. 7, 2008, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to background image and video display, and more particularly to generating an animated storyboard-themed background video and image display.

2. Description of Related Art

The electronics industry is becoming increasingly aware of patterns of device interaction toward meeting user needs and increasing utility. For example, although televisions provide a center for playing conventional telecast programming, they are increasingly being utilized for aesthetic and information dissemination purposes. One use of these display-enabled devices is the display of program schedules as a background on the television set. Another use is the display of screensavers or slideshows of user selected content. However, these aesthetics are considered cliché, and even boring, wherein additional mechanisms are sought which provide higher background display complexity and thus increase user appeal.

Accordingly, a need exists for a means of extending the utilization of devices in the display of aesthetics which appeal to the user. The present invention fulfills that need as well as others and overcomes shortcomings of previous approaches.

### BRIEF SUMMARY OF THE INVENTION

A method and apparatus are taught for generating animated storyboard backgrounds containing images and video content displayed when the associated display-enabled device is in a background mode (e.g., alternative to turning the device off).

A number of different display-enabled devices can implement the method with a desired level of complexity, such as determined in response to the size of the display and the amount of processing overhead which can be sustained. By way of example, and not limitation, the user interface is generally spoken of herein as being that of a television device, although the invention may be implemented on any programmable electronic device having a display screen (display-enabled). The method is particularly well-suited for use on large display screens, such as television sets, or equivalently televisions comprising separate tuner and monitor. The method may also be implemented on other devices which include but are not limited to: entertainment system control centers, advertising displays, image projection walls, kiosks, electronic books, personal digital assistants, cell phones, and so forth.

Electronic devices are designed for fulfilling the designated user need while they are in an “On” state and thus operating in their traditional role. For example, when an electronic device, such as a cell phone or television is traditionally “turned off” (deactivated), it does nothing but take up space on our waist or on our walls. However, the “off-time” of these devices can be utilized to fulfill additional user desires, such as providing an aesthetic content which can include information or allow content selection, or a combination thereof. This functionality will be referred to herein as a background mode of the display-enabled device. On television sets this mode can be referred to as background television mode; however, although not descriptive the name “Ambient Player” will generally be utilized herein for the sake of brevity, and is not to be confused with ambient light detection features. Potentially, the inventive method can be integrated into any device having a suitable display and access to content, and which is subject to periods of non-use or intermittent use (e.g., in relation to conventional functions of the device).

In the present invention, the device is not turned off, but instead enters a background (or ambient) mode within which material is displayed, such as including interesting live video (or photo) manipulations which are performed automatically in response to the theme of the storyboard. Entry to this background mode can be automatic, or it may be in response to user selection, and so forth. Examples of automatic entry comprise entering into background mode in response to detecting a sufficient non-interactive time-period, detecting user absence (e.g., infrared sensing), selection of blank program sources, and so forth and combinations thereof. Examples of user selection of background mode comprise: pressing a remote control button, such as a quick press of the ON/OFF control, as contrasted to a sustained key press which is turns off the power.

Display of image and video material according to the invention follows one or more animation paradigms (referred to hereafter as simply ‘paradigm’), within which any number of themes and sub themes may be played out. Technically, a theme is thus one instantiation in the larger context of a paradigm, although the terms have substantial overlap and can be considered even synonymous when used in a general context, as both are levels of themed image manipulation.

One preferred implementation of the present invention is configured within a storyboard paradigm within which different images (live video or photos) are displayed in an interesting manner. In at least one implementation of the storyboard, one content placeholder (or alternatively two to four placeholders) are animated, wherein a video is displayed in that placeholder, or alternatively interesting effects applied to a user photo or similar. The remaining content placeholders in the storyboard are preferably shown in freeze frame (e.g., freeze frame of a video input).

The content of the material brought into the storyboard is preferably selected in response to the mode of the device, and may be subject to user selection settings and interaction. For example, in a television tuner mode, video content is selected for the storyboard content, while in user photo viewing mode, stored user images make up the content of the storyboard, and in music mode a channel (e.g., Internet radio, broadcast, cable, stored music, and so forth) may be used for information to control the storyboard, or to control the display of content obtained from other sources. In addition, the modes can interact, for example wherein a music source is selected for modulating themes and objects upon which images or videos are interacting, such as thematic object changing or object motion in response to music, and upon which live video is displayed. It will be appreciated that a wide range of sources and types of content can be directed into the storyboard paradigm of the present invention.

Each storyboard is displayed according to a theme, which may be intrinsic to the given storyboard, or selected by the user, or a combination thereof. In the simplest implementation, the theme can be based on color and shapes, while themes and sub themes can be segmented in any desired manner, such as based on objects, subject categories and the like (e.g., ocean-scapes, desert-scapes, urban, art, art nouveau, renaissance, modern art, football, high technology, sports cars, and so forth). In a preferred implementation the theme includes effects and even objects which can be applied to images and video streams, examples including morphing, editing, and in particular three-dimensional texturing in which images are used to texture objects (e.g., thematic elements) and items, for example those being part of the theme (e.g., rolling ball, car, plane, and the like). The theme itself may be variable, such as changing in response to a musical input, other patterning input, randomly, sequentially, or as a result of a combination thereof.

One implementation of the invention makes extensive use of live video texturing (LVT) for creating the animations, wherein a video stream is used as texture to be applied upon elements of the theme, which are most preferably represented in three dimensions though displayed in two dimensions. For example, if the theme element involves a rolling ball, then the live video may be applied to the exterior of the ball creating a very complex interesting effect. It will be appreciated that the interaction between theme elements and video can provide a substantially limitless range of visually interesting animations.

In general terms, the storyboard is populated with media elements (e.g., images and video), which each can be the subject of interesting manipulations, after which the elements “evaporate” (e.g., disappear in a stylized manner) and the interface is then tuned (retuned) wherein it can access other channels and favorites, or return to the same set of elements, a different set of elements, operating in a scanner mode, or a combination of the same and different elements. Accordingly, the storyboard has general operating phases referred to herein as: (1) tuning, (2) population, (3) animation, and (4) evaporation.

In a preferred embodiment, the storyboard is populated with freeze frames from a video source. During animation, one (or more) of these freeze frames are unfrozen to play the video (animation) for a period of time. Image manipulations may be applied to both the frozen and unfrozen video frames to increase the interesting effects.

In a general sense the visual manipulation (operations) can be performed on the storyboard elements to provide interesting viewing and visuals to the user, as well as animation effects to provide the animation of those elements, for example in response to loading of one or more elements of the storyboard with still images (e.g., user photos). For example, one mode of the present invention utilizes texturing operations on photos, image sequences, and video; such as live video texturing (LVT) processes to animate the storyboard theme with live video used as texture onto three-dimensional (3D) graphics objects. The layout of the storyboard theme can be changed as well as the animation effects. In one mode of the invention only one visual placeholder animates at a time (instead of multiple placeholders), thus limiting hardware overhead. Once animation of a first element completes, the next one can animate and so forth.

One implementation of the animated storyboard backgrounds defines a matrix of placeholders on the screen, which are variously populated by viewable content elements. These placeholders are shown as a two-dimensional matrix, or alternatively a more complex three-dimensional arrangement (e.g., in a stacked configuration). According to one mode of the invention the configuration of the storyboard matrix (e.g., number of elements, size, and arrangement) are determined in response to the size and characteristics of the viewing screen and preferably in combination with user settings as well (e.g., 2×2, 2×3, 3×3, 3×4, 2×4, 4×4, and so forth). In general, the matrix is a two dimensional (x, y) matrix having at least 2×2 (4 placeholders) in extent and up to approximately 12×12 (144 placeholders) in extent, although larger matrices may be supported in select applications. The number of rows/columns of placeholders in the x and y axis of the array need not be equivalent. By way of example, one preferred configuration of the storyboard comprises a 4×4 matrix of elements, although this matrix can be made larger or smaller as desired in different modes or implementations.

At least one mode of the invention allows more than one of the elements (frames) to be playing at the same time, for example during the frame time period, or overlapping a portion of the prior frame or the next frame. Thus, the frame animations can spatially or temporally overlap one another as desired. In addition, modes of the invention allow user selection of how frames are selected; for instance in one variation, the user can select frames, such as utilizing the directional keys of a remote control device to select a given frame. It will be appreciated that a wide range of configurations and interactions can be supported without departing from the teachings of the present invention.

The invention is amenable to being embodied in a number of ways, including but not limited to the following descriptions.

One embodiment of the invention is a method of generating a storyboard themed animated display background for a display-enabled device, comprising: (a) entering into a background mode of a display-enabled device; (b) tuning the input of the device to select viewable content; (c) generating a storyboard configured for receiving elements of the viewable content within a matrix of content placeholders; (d) populating the matrix of content placeholders within the storyboard with the elements of viewable content (e.g., video freeze frames) and displaying the storyboard; (e) generating animations for each element in the matrix of elements (e.g., unfreezing the freeze frames to play that portion of the video); (f) removing each element in the matrix of elements of viewable content; and (g) repeating the cycle by returning to the tuning step until the termination of background mode.

In at least one implementation the viewable content comprises any of a number of different types of material which can be displayed on the screen including photo content, image content, graphic content, video content, and so forth. In addition, non-viewable content can be retrieved, such as music or files, for modulating the effects performed on the storyboard elements.

In at least one implementation the tuning is performed by collecting viewable content from streaming content sources, or stored content, or network content, and combinations thereof. In one mode of the invention tuning is performed according to retrieval from a list of user favorites from within a set of channels, source inputs, or content sources. The storyboard matrix is preferably a two dimensional (x, y) matrix which is at least 2×2 in extent and up to 12×12 in extent; wherein the x and y array dimensions need not be equal. It should be appreciated that the content placeholders need not line up with the edges of the screen, as a mode of the invention allows portions of the content within the placeholders to extend from the edges of the screen, and in a related aspect the positioning of the content placeholders can be modulated wherein more or less of the content within these placeholders is shown on the display screen. The system can be set to either display or not to display the placeholders on the display screen. Display of the storyboard and its viewable content elements are according to a selected theme to which the storyboard and content therein is modified by image manipulation.

In one implementation, each theme comprises common color tints and patterns to which the elements of viewable content are modified, and in particular the freeze frames (non-animated elements).

In one implementation, animations are performed by playing video from the freeze frame shown during population. The freeze frames can be temporally displaced throughout the video segment, or clustered within an area of the video segment or any combination thereof. The system is configured so that image processing may be performed on the freeze frames and/or the video segments being played. Examples of simple effects applied to the animating (playing) of a video segment is lens flare and video texturing, as well as other effects known in the art.

In one implementation, animations are performed by applying one or more animation effects (non-static image effects) to the elements of viewable. This is particular suitable for situations in which the elements in the storyboard comprise static images.

In one implementation, elements of the viewable content are sequentially animated and then removed from the matrix of content elements displayed in the storyboard.

In one implementation, the storyboard elements are removed according to a transition effect which terminates with the removal of the content elements from the storyboard, such as terminating the transition effect, or effects, with a fadeout effect performed on the content element. It should be recognized that different types of fadeout effect exist, such as by increasing transparency toward 100%, and/or shrinking the area of the element toward 0%, while other fade mechanisms may be adopted according to the present invention without limitation.

In one implementation, the removal of matrix elements is performed in combination with tuning and populating the placeholder matrix, wherein new elements of viewable content replace prior content being removed.

One embodiment of the invention is a method of generating a storyboard themed animated display background for a display-enabled device, comprising: (a) entering into a background mode of a display-enabled device; (b) tuning the input of the device to select viewable content, wherein the tuning is performed by collecting viewable content from streaming content sources, or stored content, or network content, and wherein the viewable content comprises photo content, image content, graphic content or video content; (c) generating a storyboard configured for receiving elements of the viewable content within a matrix of content placeholders; (d) populating the matrix of content placeholders within the storyboard with the elements (e.g., freeze frames) of viewable content and displaying the storyboard; (e) modifying the storyboard and its viewable content elements in response to a selected theme which modifies tints and/or patterns; (f) generating animations, by unfreezing freeze frames and/or by applying one or more animation effects to the element of viewable content being animated according to the theme, for each element in the matrix of elements; (g) removing each element in the matrix of elements of viewable content by performing a transition effect which terminates with removal from the storyboard of a specific element in the matrix of elements; and (h) repeating the cycle by returning to the tuning step until the termination of background mode.

One embodiment of the invention is an apparatus for generating a storyboard themed animated display background for a display-enabled device, comprising: (a) a computer of a display-enabled device configured for processing sequences of images; and (b) programming executable on the computer for, (b)(i) entering the display-enabled device into a background mode and starting a storyboard cycle, (b)(ii) tuning the input of the display-enabled device for selecting viewable content, (b)(iii) generating a storyboard configured for receiving elements of the viewable content within a matrix of content placeholders, (b)(iv) populating the matrix of content placeholders within the storyboard with the elements of viewable content (e.g., freeze frames) and displaying the storyboard, (b)(v) animating each element in the matrix of elements, such as by unfreezing the respective freeze frames, (b)(vi) removing each element in the matrix of elements of viewable content, and (c) repeating the storyboard cycle by returning to the tuning step until the termination of background mode.

One embodiment of the invention is a computer-readable media containing a computer program executable on a computer of a display-enabled device configured for controlling the display of still and video images on an associated video display, comprising: (a) entering a display-enabled device into a background mode; (b) tuning the input of the device to select viewable content; (c) generating a storyboard configured for receiving elements of the viewable content within a matrix of content placeholders; (d) populating the matrix of content placeholders within the storyboard with the elements of viewable content (e.g., freeze frames) and displaying the storyboard; (e) animating each element in the matrix of elements (e.g., by unfreezing content and/or by utilizing animation effects; (f) removing each element in the matrix of elements of viewable content; and (g) repeating the cycle by returning to the tuning step until the termination of background mode.

The present invention provides a number of beneficial aspects which can be implemented either separately or in any desired combination without departing from the present teachings.

Another aspect of the invention generates a storyboard themed mechanism for displaying images and video in the background of a display enabled device.

Another aspect of the invention is a background display mechanism wherein a plurality of content source elements are displayed within the storyboard theme.

Another aspect of the invention is a background display mechanism in which image or video content elements can be displayed.

Another aspect of the invention is a background display mechanism in which a storyboard is populated by freeze frames of a video.

Another aspect of the invention is a background display mechanism in which a storyboard is populated by still images, such as from user photo content.

Another aspect of the invention is a background display mechanism in which a selected storyboard elements enters animation mode by unfreezing of the video frame and thus playing the video in that position of the storyboard.

Another aspect of the invention is a background display mechanism in which a selected storyboard elements enters animation mode by unfreezing of a video freeze frame and thus playing the video in that position of the storyboard.

Another aspect of the invention is a background display mechanism in which content images and video are manipulated according to a theme while being animated during display.

Another aspect of the invention is a background display mechanism in which multiple content placeholders are supported within a single display.

Another aspect of the invention is a background display mechanism in which a screen is populated with elements, the elements sequentially animate and then evaporate from the screen.

Another aspect of the invention is a background display mechanism in which tuning is performed from which groups of elements are collected for display.

Another aspect of the invention is a background display mechanism in which content elements are brought in to populate a storyboard matrix wherefrom the elements are animated and from which they then evaporate.

Another aspect of the invention is a background display mechanism in which content elements are utilized as input for live video texturing.

A still further aspect of the invention is wherein element content is obtained through tuning according to a list of user favorites.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a processor controlled electronic device upon which the background storyboard theme is executed according to an embodiment of the present invention.

FIG. 2 is a flowchart of the background storyboard theme method according to an embodiment of the present invention.

FIG. 3 is a selection diagram of user-interface control of the background storyboard theme according to aspect of the present invention.

FIG. 4 is an image of a display screen within which the background storyboard theme is being executed according to an aspect of the present invention.

### DETAILED DESCRIPTION OF THE INVENTION

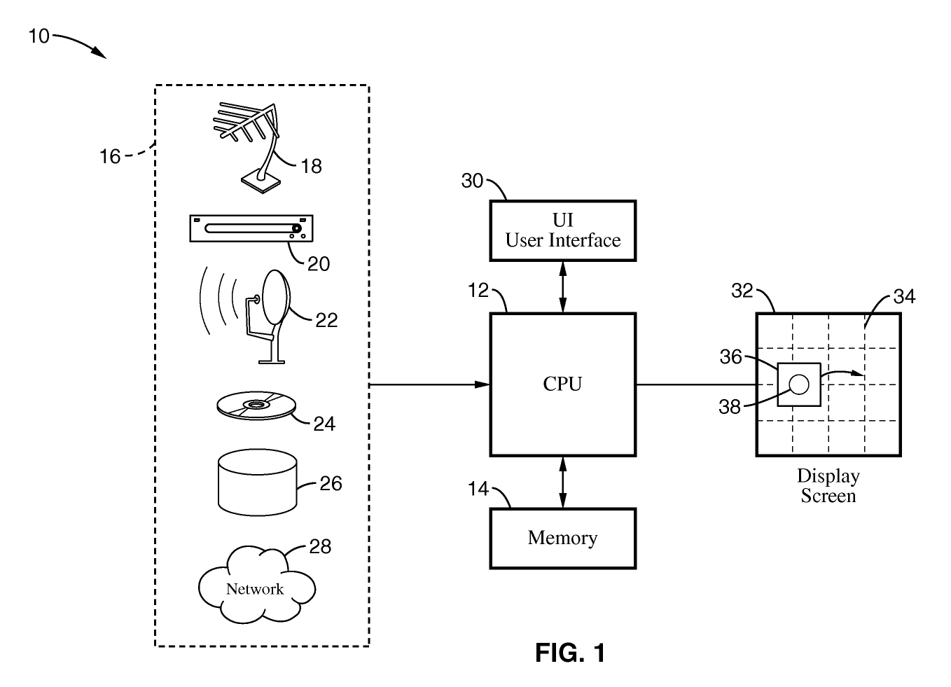

Referring more specifically to the drawings, for illustrative purposes the present invention is embodied in the apparatus generally shown in FIG. 1 through FIG. 4. It will be appreciated that the apparatus may vary as to configuration and as to details of the parts, and that the method may vary as to the specific steps and sequence, without departing from the basic concepts as disclosed herein.

It should be appreciated that the following detailed description provides numerous details about one specific implementation of the invention, so as to further understanding of the technology; however, the teachings herein are not limited to these specific embodiments.

### 1. Ambient Player Overview and Access.

1.1 General Description.

The concept of ambient (background) storyboard player, hereafter referred to as “Ambient Player” for the sake of simplicity of description, is that with minimal effort an ambient, beautiful, entertaining visual experience can be displayed on a television screen. The following describes a storyboard paradigm of the Ambient Player, in which a plurality of elements populate the screen, proceed through an animation phase and evaporation phase, after which a tuning phase is entered in which the same, or more preferably, other elements, populate the screen and the process continues.

Each storyboard is preferably played according to a theme. The themes may be embedded within the storyboard, or be subject to selection, or a combination of the two. Interesting names are preferably attached to the themes toward supporting different user experiences. Elements in a storyboard progress through a series of phases, after which another set of elements are picked up to start another storyboard.

FIG. 1 illustrates an embodiment 10 of a display-enabled device upon which the storyboard animated background can be displayed according to the invention. At least one central processing unit (CPU) 12 is configured for controlling image processing (still and video image processing) of the storyboard. It will be appreciated that the CPU may comprise one or more of any of the following: processing core, microcontroller, microprocessor, digital signal processor (DSP), or application specific integrated circuit (ASIC) containing a processing core. Memory 14 is shown within which content can be stored, and from which programming is executed for performing aspects of the present invention. It should be appreciated that memory 14 can comprise any desired combination of internal semiconductor memory, mass storage (e.g., disk drives), media devices (e.g., memory sticks, memory cards, optical disk media, and so forth). The memory may be configured for storage of viewable content for the system, such as photos, video, and/or graphics.

A content source block 16 is shown from which viewable content may be retrieved for populating the animated storyboard background. By way of example and not limitation, these content sources comprise: radio-frequency (RF) broadcasts 18, cable broadcasts 20, satellite broadcasts 22, media based content 24, media stored in memory and on mass storage devices 26, and media received from local networks or the Internet 28.

A user interface 30 is shown to provide user access for controlling operational aspects of device 10. It will be appreciated that the user interface typically comprises means for the user to input commands and a means for the user to receive status information back from the device.

A display 32 is shown upon which device 10 can display the storyboard animations according to the present invention when it is operating in a background mode. By way of example a storyboard placeholder matrix 34 is shown within which viewable content elements are placed prior to or subsequent to animations performed on them. A content placeholder 36 is shown with an element of content, within which is shown an object 38 seen during animation, such as a structure upon which live video is applied as a texture according to an LVT animation process.

1.2 Overview of Storyboard Animation Process.

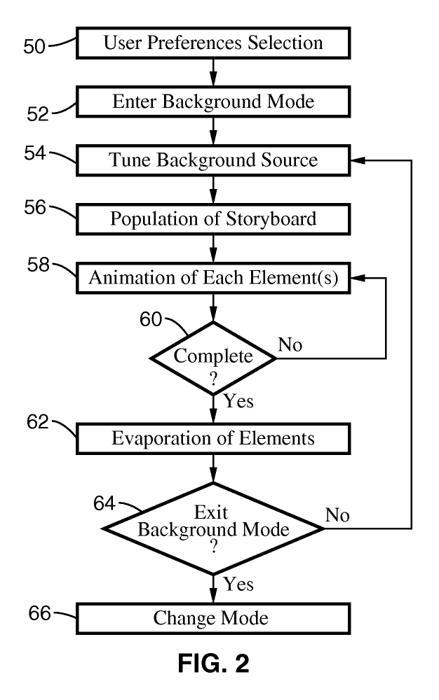

FIG. 2 illustrates an embodiment of a method for performing the background storyboard themed animations according to the present invention.

In block 50 the system is configured to allow the user, as desired, to set preferences for how and when the storyboard animations are to be performed. When conventional use of the device is completed (e.g., user has finished watching a television program), then as represented by block 52 a background mode is entered, or can be entered in response to user selection. Content is collected for the background animations by tuning, as per block 54, a background source, such as collecting video from a television broadcasting channel selected from a user “Favorites” list. Once selected, block 56 represents population of the storyboard, wherein content placeholders of the storyboard matrix are filled as content elements are retrieved. It should be appreciated that delays may be introduced between population of each placeholder, such that a “pop” effect may be performed as the content element is displayed as being brought into the storyboard, even if the content has already been retrieved. In a preferred implementation, all content elements are loaded into memory before being candidates for population, wherein the rhythm of population is not affected by delays or errors in retrieving content.

Each of the storyboard elements is animated as per block 58, such as sequentially, randomly or a combination. If the storyboard is populated by freeze frames of video content, then when these are animated the video begins playing from the freeze frame shown. Depending on the theme, the animated content may be subject to image manipulation effects, such as live video texturing, to enhance the complexity and aesthetic of the animated frame. Less preferably, other forms of content can be utilized within the storyboard, including still images, wherein animation can be performed on these images with the application utilizing one or more animation effects. Animations continue until completed as determined in block 60. In one mode of the invention, the animations are completed when each element has been animated a single time. It will be appreciated that other criterion for completion can be utilized, such as in response to animation of only a selected number of elements, animating each element N times, performing animations for a desired period of time, and other criterion for determining arriving at an end to the animations.

After the animation phase, or in combination with the animation phase, content elements are removed as per block 62, which is referred to as evaporation, since the preferred mechanism of removal involves a transition effect which preferably concludes with a fade from the storyboard.

If the device remains in the background mode, then processing continues with another tuning phase at block 54, otherwise if background mode has terminated as detected in block 64, then the device enters into mode changing as given by block 66.

1.3 Details of Storyboard Phases.

The preferred implementation of the storyboard paradigm includes a number of stages (phases), which can be executed separately or having some portions overlapping other phases. These phase are described by the following.

A. Population Phase. Population is preferably performed in response to a visual freeze frame metaphor in which frames (content placeholders) containing a frame of video appear and populate the screen, such as in an array format (e.g., 4×4 matrix).

The content in each freeze frame is preferably modified according to a theme or pattern of themes, for example in one mode the theme may be based on color tints and/or patterns, wherein each of the images are tinted with shades of the same color, or alternatively different colors, within a pattern style. These populated frames can be subject to additional image modification to enhance interesting visual effect, such as by showing the content in reflection (e.g., horizontal or vertical flipping) of image content, rotation of image sections, highlighting objects (e.g., people, moving objects, and so forth), reversing chroma, color replacements, as well as other simple effects. It should be noted that themes may be directed to common styles, subjects, structures, colors, patterns and/or shapes and so forth as desired, and are preferably organized hierarchically with themes and sub themes to any desired depth of complexity.

It should also be noted that the system is configured to allow populating the storyboard with still images, such as user photos; wherein during animation this content can not be ‘played’ per se, but is preferably subject to animation effects, wherein active moving aspects are created in response to image manipulation processing.

B. Animation Phase. Various freeze frames (e.g., one frame, or a portion of the frames) enter an animation phase, preferably selected according to a predetermined pattern or one controlled in response to internal or external conditions. If the frame is a freeze frame image then during animation the video begins playing, preferably from the point shown in the freeze frame. If the frame is a still image (e.g., photo image) then one or more animation effects is preferably applied to instill a motion aspect to the still frame. It should be noted that during animation both still images and video can processed by one or more image manipulations, such as lens flaring, live video texturing, as well as other image manipulation processes and combinations thereof. The system can support animating more than one of the elements (e.g., one, two, . . . four, or a portion of the content placeholders—depending on the size of the display screen), insofar as sufficient image processing bandwidth remains.

By way of example and not limitation, the last freeze frame to populate the storyboard scales up (size increases) and it is played, (e.g., from live or stored content) for a short period of time. For example, the short time period of time can be predetermined, such as given in seconds, or determined in response to user settings; or established in response to conditions and material, and/or combinations thereof. After displaying the video or images, the frame shrinks back to normal size and returns to the original theme or a new theme, such as tinting to some different color or patterns.

C. Evaporation Phase. After the animations have completed (e.g., all elements or a selected subset thereof), then an evaporation phase is entered in which the freeze frames disappear, such as according to a desired pattern or randomly. The evaporation can include any forms of disappearance; with preference to stylized forms such as the graphic changing size, shape, transparency, patterns, morphing and so forth during the process of evaporating and thus disappearing from the screen. In one mode of operation, after the evaporation phase, another population phase commences, followed by animation and evaporation, with the cycle repeating.

D. Tuning Phase. In at least one mode of the invention, prior to entering the population phase, the device (e.g., television) is tuned for selecting and collecting viewable content from streaming content sources (e.g., RF broadcasts, satellite broadcasts, cable broadcasts), stored content (e.g., user stored content, content stored on fixed or removable media), network content (e.g., local network, or the Internet), and/or combinations thereof. It will be appreciated that in one mode of the invention, the first population phase may operate in response to at least some previously stored material, wherein the storyboard process is not subject to fetching delays. The tuning phase can be understood to follow evaporation, as discussed here, or to precede or overlap the population phase.

It should also be appreciated that the storyboard can be populated from a single source, or from multiple sources. In considering the use of a single video source, perhaps the most typical mode, then content placeholders are populated by freeze frames within the video, such as selected in response to their temporal displacements within the video content (e.g., selection may be configured for clustering or dispersing the selection of frames within the selected video content source). If a still image source is selected, then multiple still images are selected from this one source, or from additional sources as desired. It will be appreciated that at least one mode of the invention allows the user to select the number of video or still content sources to be input to the single storyboard.

By way of example and not limitation, within a simple embodiment upon entering the tuning phase the device is “tuned” to the first channel selected in a Favorites category (e.g., user selected favorites). Alternatively, or if Favorites do not exist, then a history mechanism can be utilized to select channels, or the selection made in response to preset user settings, predetermined selection patterns, a sequential selection performed, or other mechanisms and combinations thereof.

In one mode of the invention, when all channels have been played in the favorites list, history, or other selection mechanisms or combinations thereof, the channels being used for collecting storyboard material will again be selected, such as by going through the selection loop again.

### 2. Details of a Simplified Embodiment.

The main criterion for a simplified embodiment of the Ambient Player is to provide a passive application requiring little or no user interaction beyond initiation. For example in this mode error messages are eliminated or minimized so as to prevent interruptions to the users. In addition, the application is readily launched with a simple selection implementation preferably including only a theme switching mechanism. By way of example, if the user presses a <SELECT> button (e.g., on the device or a remote control for the device) during animation then the television exits from Ambient Player mode and returns to full screen viewing mode of the selected item in a conventional manner, or alternatively utilizing the same animation effect, such as LVT, depending on device setup. In one mode, the system tunes in another channel each time the “evaporation” effect is used. In this simplified embodiment, a limited set of themes (e.g., two for the sake of simplicity) are available within the Ambient Player.

The following sections outline paradigm and theme utilizations and animations for a simplified embodiment. Screenshots and text are provided here by way of example and not limitation.

2.1 Ambient Player Access.

In one simplified mode the Ambient Player is accessed from the remote control by pressing <Favorites> or <Options>.

2.2 States in which Ambient Player is Available.

Ambient Player can be accessed at any time for any available input, including but not limited to the following: RF (radio-frequency), composite, component, high-definition multimedia interface (HDMI), and DMPort, PC. Ambient Player is also accessible whenever the user selects USB or DLNA mode.

The player can be accessed via the <FAVORITES> button or the <Options> button, except for interrupting certain other applications (e.g., Initial Setup, Auto Program, Digital Channel Add, and so forth).

2.2.1 Order of Themes in New Favorites or Options.

The order for themes to appear in “New Favorites” or “Options” can be based on any desired metric, such as alphabetical order according to English names: “Clock Pop”, “Lens Flare”.

2.2.2 Accessing Ambient Player Via New Favorites.

To access Ambient Player via New Favorites, the user presses the <Favorites> button to launch New Favorites. Then the user can navigate to the desired Ambient Player theme by using the directional arrows and pressing select to launch Ambient Player with that theme (if Ambient Player themes are in the Favorites, either by default or as defined by the user). Within a content carousel, each Ambient Player theme is preferably represented by a canned animated icon (a mini “preview” of the theme).

2.2.3 Accessing Ambient Player Via Options.

In one implementation of the invention, the user interface utilizes a Xross Media Bar (XMB) interface wherein focus remains centralized and intersected by menu traversal bars. XMB is a graphical user interface developed by Sony which has icons spread horizontally across the screen. When the cursor keys are pressed, the icons move instead of a cursor moving over the icons, thus the center focus remains the center focus. Icons are used as categories to organize the options available to the user. When an icon is selected on the horizontal bar, several more appear vertically, above and below it which are selectable in response to up and down cursor directions. Although the XMB interface provides an attractive and easy to navigate interface, it should be appreciated that embodiments of the present invention may be implemented utilizing alternative interface paradigms without departing from the teachings of the present invention.

The Options menu for the television preferably contains a selection for the Ambient Player as described in the following sections. Whenever Slideshow or Music Visualizer is accessible from the Options menu, Ambient Player should be accessible. When the user selects Ambient Player from the Options menu, the Options sub-menu displays the available themes (e.g., two themes). In a simplified embodiment, selecting a theme will launch that specific theme. In more complex embodiments a plurality of themes may be chosen for use separately, or in combination with one another.

2.2.4 Ambient Player Activation and Theme Selection.

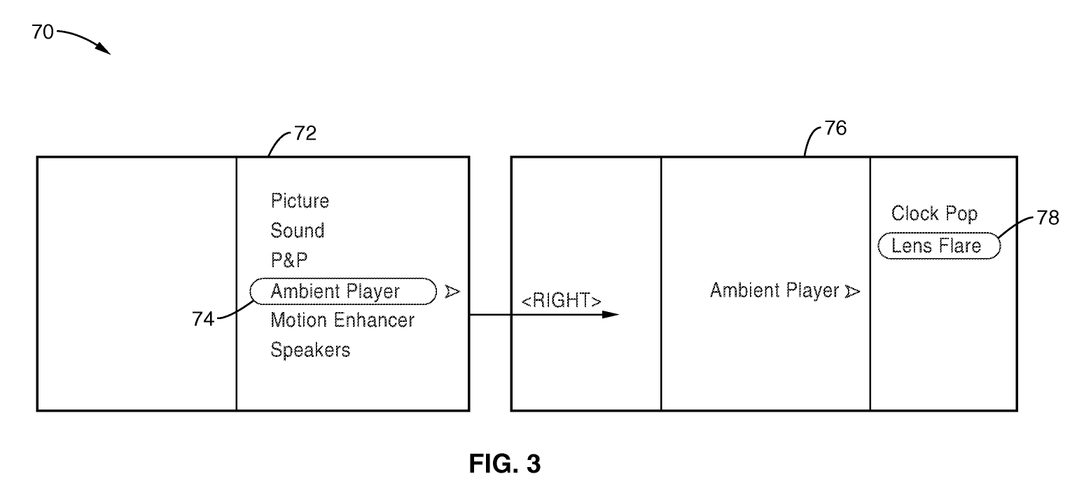

FIG. 3 depicts an example user interface 70 in which a menu 72 is shown from which Ambient Player mode 74 is selected. On entering Ambient Mode, then the user can select as per menu 76 the type of background animation to be performed, such as lens flare 78, from a list of type and/or themes. In this case “lens flare” is selected which is a theme based selection within a storyboard paradigm. It will be appreciated that mode selection can be subject to additional paradigms, themes and/or sub themes without departing from the present invention, and that each may be given a single descriptive name (e.g., Lens Flare, or Clock Pop), wherein the user need not traverse multiple user-interface (UI) levels to make a selection.

2.2.5 Accessing Ambient Player Via XMB.

One implementation of the invention, In response to an XMB Standard, does not allow the Ambient Player to be accessed from the first layer of XMB; and delegates this selection to a second or third layer selection.

Examples of XMB selection within a simple Ambient Player embodiment: (A) user actions: XMB > Music> USB: Options Menu will not have Ambient Player listed under Options; (B) user actions: XMB > Music > USB > User's Folder: Options Menu will have Ambient Player listed under Options; (C) user actions: XMB > External Inputs > HDMI: Options Menu will not have Ambient Player listed under Options.

2.2.6 Default Focus for Options.

In this illustrative example, whenever Ambient Player mode is accessible via Options, the theme last launched (e.g., either through New Favorites or Options) is preferably configured with the default focus (context of user interface) in the Options sub-menu. The programming preferably is configured (e.g., predetermined or loaded accordingly) with a default focus, for example the first time the Ambient Player is operated the focus may be on the LVT theme element, such as “Lens Flare”.

2.2.7 Non-RF Modes: External Video Inputs.

Accessing Ambient Player from Options when in External Input mode including PC input mode will launch the Ambient Player.

2.2.8 Non-RF Modes: XMB Photo/Music Viewer.

When in modes such as the XMB Photo or Music viewer, the simplified embodiment of the Ambient Player exits from Photo or Music Viewer, and displays the Ambient Player using content from that mode. Again, Ambient Player is accessible whenever the Slideshow or Music Visualizer is accessible.

2.2.9 Multi-View (PIP/PAP).

Although the Ambient Player can be utilized with respect to features such as picture-and-picture (PAP/P&P) as well as picture-in-picture (PIP) modes, the menus for these options do not display an option for Ambient Player in this simplified Ambient Player implementation.

2.3 Exiting Ambient Player.

In one embodiment of the invention the user is not allowed to exit Ambient Player via Options. For example, the user can return to their previous mode by either pressing the remote control commands available to exit Ambient Player or the receipt of non-user initiated events can cause the Ambient Player to exit.

2.3.1 Exiting Ambient Player Accessed from Favorites.

If the Ambient Player mode was originally accessed from Favorites and the user then presses <HOME>, then XMB UI is displayed over wallpaper with the focus on the last input/channel/application that was utilized before launching the Ambient Player. If <HOME> or <RETURN> are pressed, XMB over wallpaper is preferably removed and Ambient Player returns.

2.3.2 Exiting Ambient Player Accessed from Options.

Accessing Ambient Player via Options will launch Ambient Player. If the user presses <RETURN> Ambient Player exits and the current input, channel, or application is displayed.

### 3. Content Priority and Rules.

One simplified example implementation of Ambient Player provides two (2) themes, with the ability to switch between themes. It will be appreciated that implementations and modes of the present invention allow themes to be created, downloaded, edited and so forth. Each of these themes is preferably configured for using video and audio from any desired source, (e.g., a user device, or built-in content) to which any form of image manipulation theme may be applied, such as LVT. In one preferred mode, if the input or mode selected by the user allows LVT, then LVT is utilized by itself or in combination with other effects for all content presented.

3.1 Theme Content Rules.

By way of example and not limitation, one implementation is described as having the following limitations: (a) all themes that use photo or audio content will shuffle (randomly select) through content; (b) all themes are configured to allow for operation on all manufacturer television models with or without a specific multimedia category configuration, such as photo/music XMB category; (c) shuffling through content from another device (USB or DLNA) is not allowed in this implementation; and (d) shuffling through folders or embedded folders (folders within folders) is allowed.

### 4. Ambient Player Paradigms and Themes.

At any one time the Ambient Player operates according to a single animation paradigm, although additional paradigms can be created by combining aspects or temporal phases of existing paradigms. One or more themes can be brought out within the single animation paradigm, this theme being carried to each element, or visual placeholder, subject to the given paradigm.

In one example, a storyboard paradigm is adopted which is configured to contain sixteen visual placeholders (e.g., 4×4 element arrangement), such as with dimensions of 226×128 pixels each or as defined by the file layout. In particular, the term “visual placeholder” is used to refer to a container object within which visual content or photo content is placed and manipulated, while the term “element” refers to an instantiation of the visual placeholder, although these terms can be utilized somewhat synonymously herein.

4.1 Storyboard Effects.

A number of different effects can be applied when animating one or more of the elements of the storyboard, or to a lesser extent when evaporating those elements. It will be appreciated that the effect can be an integral aspect of the paradigm or contained within the theme, as the division between what constitutes the paradigm and theme can be defined in various ways within any given implementation. Two examples of effects that can be applied to the elements of the storyboard during animation are lens flare effect, and live video texturing (LVT) effect.

Traditionally, lens flare is the effect that arises when light is scattered in a lens systems through generally unwanted image formation mechanisms, such as internal reflection and scattering from material inhomogeneities in the lens. However, as a graphics effect, lens flare can be generated as a brightness effect with optional ancillary effects such as hexagonal halos (e.g., old style physical aperture shape), starbursts, rings, or circles, and so forth.

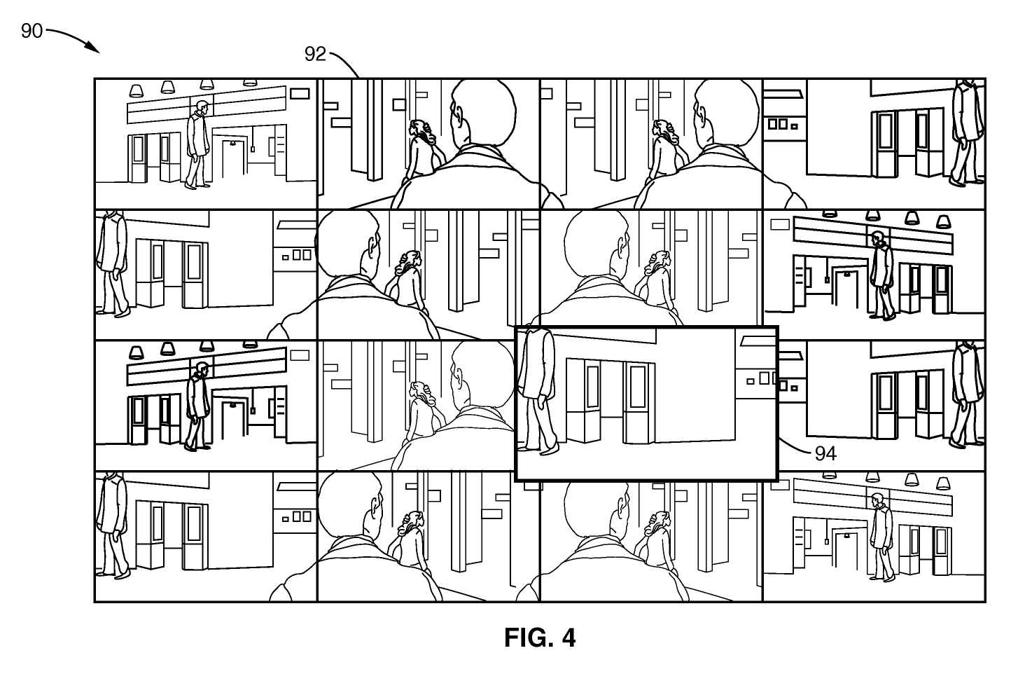

FIG. 4 illustrates a storyboard animation embodiment 90 having a plurality of freeze frame elements 92, one of which is the animated element 94 of the storyboard. A portion of the viewable content elements 92 (e.g., freeze frames) are shown in this example being displayed in response to reflection effects, although other image effects, preferably low processor overhead effects, may be utilized. Animated element 94 is shown being animated by unfreezing the freeze frame to play the video and preferably including a lens flare effect, although other effects and combinations of effects may be applied (e.g., LVT). Element 94 is preferably a video clip, or less preferably an image to which animation effects are applied. It will be appreciated that the animated element is preferably subject to motion, changing forms of image modification (e.g., LVT) or the like, so that it stands out and provides motion which distinguishes it from the viewable content elements which are not selected. Although the other elements are shown in freeze frame in this example implementation, it will be appreciated that their respective image can be subject to modulated image effects, or freeze frame updates, and less preferably to the display of video, such as at a low-frame rate.

In a preferred embodiment, the storyboard is populated by still images, a portion of which (e.g., preferably one or two) are animated by applying one or more animation effects to the still images within that content placeholder.

In a more preferred embodiment the storyboard is populated by freeze frame or still images; while animation is performed on a portion of the still images by unfreezing the video of a freeze frame so that it plays in that content placeholder, or by applying one or more animation effects to still images within a still image placeholder.

In a most preferred embodiment the storyboard is populated by freeze frame images; while animation is provided in response to unfreezing the video of the freeze frame so that it plays in that content placeholder.

A reflection effect provides a reflection effect viewable content, typically about a vertical axis (exchanging right and left side of the image), although reflections can be performed across the horizontal axis, or about an axis at any angle, or multiple axes, points, and so forth. Reflection effects are utilized in the current embodiment on the freeze frames. In one mode of the invention, the effects can be modulated, such as images change from reflected back to normal images, and back and forth, either periodically or in response to conditions or combinations thereof.

It should be appreciated that numerous effects can be utilized for animating the elements of the story, with lens flare, and LVT being just two examples. Numerous video and image effects can be utilized within the themes including, but not limited to: cropping, selective color change, image gradient, image orientation, perspective distortions, lens distortions, sharpening and softening, image merging, image slicing, changing color depth, inverting colors, swapping colors, contrast change, brightness changes, overall color adjustments, line art conversions, sepia conversion, other special effects and so forth. It will be appreciated that so called “special effects” are a category of image effects which encompasses a vast range of image effects, including but not limited to: texturing, video texturing, morphing, wave distortions, pattern effects, transition effects, lighting effects, environmental effects (e.g., snow, rain, hail, lightning), starburst effects, image combining, inclusion of computer generated graphics, and so forth.

It should also be appreciated that live video texturing (LVT) is but one form of special effect which itself can be configured for texturing the video onto various forms, such as applying the viewable material being input to either the interior or exterior of cubes, cylinders, waves, disks, stars, globes, and any other structures and objects for applying the texturing. In addition the LVT effect can be applied in a manner of secondary object reflections and shadowing, such as marble shadows.

4.2 Example of Population, Animation and Evaporation.

The following describes a simplified implementation of the ambient storyboard, although it will be appreciated that this can be extended and varied without departing from the teachings of the present invention.

4.2.1 Population with “Random Pop” Algorithm.

Upon starting the storyboard in this implementation, freeze frames of LVT “pop” into existence, such as into random locations. In one mode these freeze frames will be represented with different tints of one color.

4.2.2 LVT Animation.

By way of example and not limitation, the last picture to “pop in” is replaced by the LVT and grows larger to any desired extent (e.g., approximately 110-150%), and is animated, thus playing, for a desired length of time (e.g., approximately 10 seconds). At the end of 10 seconds, it will freeze, change to another tint color (different than the ones set originally) and shrink back down to the original size.

4.2.3 Evaporation.

During the time one element is subject to LVT animating (e.g., at 8 seconds), one or more other elements is undergoing a transition effect in being removed from the storyboard, thus evaporating. By way of example this evaporation may be performed in response to selection of one of the elements (freeze frames), such as randomly selected, which enters a transition effect for instance one or more stylized fades. At the end of the animation, the LVT effect stops, and another frame is used for LVT animating at the location of the random freeze frame. Thus, there is preferably a brief overlap in time (e.g., two seconds), when two objects are animating. The next element then enlarges as well and follows the “Random Pop” Algorithm specified above, or other form of effect used. In one mode of the storyboard, once the first set of elements (freeze frames) populate and fill the empty screen, then subsequent LVT freezing leaves freeze frames of different colors.

4.2.4 “Evaporation” Effect.

In one mode of the invention an animation effect periodically occurs (e.g., every five minutes), with the current LVT finishing its animation. All freeze frames then pop out of existence, such as in a similar manner as the effect utilized to populate the freeze frames in the beginning. These freeze frames later pop back into existence and the “Random Pop” Algorithm described above is carried out again.

4.2.5 Tuning to Other Channels.

In one mode of the invention, as the “Evaporation” effect is applied, the LVT image processing begins again. This time, the video source for LVT is selected according to user favorite selections, such as tuning to the first channel in the user favorites list (“Favorites”). If no channel items exist in Favorites, then “History” is utilized for a basis of selection (e.g., excluding non-RF and composite if available in History). If nothing is found in History (besides the current channel), then the video source for LVT is selected from the entire channel map for the television set (e.g., starting from the lowest available channel for current tuning mode, antenna or cable), and the animations begin playing. When channels in the Favorites list, History list, or user's channels have been played then the source selection list preferably starts the process over again. It will be appreciated that user selections can be collected by the system to control the priority and preference for each channel; for example one may prioritize the selection (e.g., 1^{st}, 2^{nd}, 3^{rd}, . . . n^{th}), or select a specific portion of the source content (e.g., 10%, 25%, 50%, etc.) to be taken from a single channel—and then loop through that list again. In addition, modes of the system are configured for allowing a selected amount of randomized selection, selection in response to characteristics of the video feed (e.g., content of programming on those channels from list), user preferences and combinations thereof.

4.2.6 Exiting Storyboard.

In one mode of the invention, when the user presses <SELECT> during storyboard operations (e.g., LVT animations), device programming causes an exit from Ambient Player mode and returns to an operational mode, such as full screen viewing of the item being displayed in the LVT animation. By way of example, each time the “Evaporation” effect is used, another channel is tuned.

4.2.7 Storyboard Operation in Photo Mode.

As discussed previously, the content for the storyboards can be selected from any image or video source. One such source is the selection of photos, examples of which include from photo albums established by the user, freeze frames selected from content previously played on the system, content from media (e.g., CDs. DVDs, Blue-Ray disks, memory sticks, and the like) web site content, and other image source content. In one mode of the invention, the processing of photos operates in a similar manner except that the pictures preferably appear for a different period of time, such as a shorter period of time (e.g., approximately 5 seconds each). In cases in which insufficient photos exist to fill the element matrix, the entire screen can be filled with as many of those photos that will fit after all existing photos have been placed.

### 5. Errors and Error Messages.

In one implementation of the invention, messages about the content or operations is displayed on the screen, for example displaying messages about a video clip (e.g., clip messages) in the lower right corner preferably over the selected Ambient theme and subject to selected display conventions.

5.1 Fetching Algorithm.

Since the Ambient Player is directed toward encouraging a passive experience it is preferable that operations revert to built-in viewable content (e.g., video, photos or audio), rather than exiting the Ambient Player application, in response to detection of an error.

It will be appreciated that the system is directed toward providing a seamless experience, wherein error message, clip messages, and content fetching delays are undesirable. A preferred implementation of the system utilizes readily available content for an element, if other content is delayed in the fetching process, or will wholly select alternative content, if the source continues to be problematic.

By way of example and not limitation, if photo or audio content is not available, the system immediately reverts to animating built-in photos or audio sources. While animating one built-in photo or audio element, additional photos or audio are prefetched. If fetching is successful, then this content is utilized, otherwise the system preferably reverts to readily accessible content, such as that already fetched, built in images, or based on history of prior content sources.

5.2 Animation with Respect to Playback States.

In one mode of the invention, if the Ambient Player is started while video playback is in a non-typical state, such as fast forward, rewind, or pause, then the state is displayed within the animation video, for example showing the forwarding in the visual placeholders with or more preferably without LVT or other complex effects.

### 6. Conclusion.

The present invention provides a method and apparatus wherein a non-active state of a display device is utilized in a background mode as what is referred to herein as an “Ambient Player”. In this mode the system is configured to animate image and video elements from selected sources in an interesting manner. In one particular example, a storyboard paradigm is populated with freeze frames from a video and subject to a theme (e.g., tinting and/or patterns), followed by unfreezing selected frames during an animation phase, and followed by evaporation of the content. The populated frames and animated frames can be subject to interactions and utilize various imaging effects, such as live video texturing. A number of states are described through which the objects are processed within the Ambient Player, including population, animation, evaporation, and tuning. It will be appreciated that the specific paradigms, themes and sub themes described were provided by way of example, wherein one of ordinary skill in the art may create new paradigms, themes and sub themes without departing from the teachings of the present invention.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of generating a storyboard themed animated display background for a display-enabled device, comprising:
entering into a background mode of a display-enabled device;
tuning the input of the device to select viewable content;
generating a storyboard configured for receiving elements of said viewable content within a matrix of content placeholders;
populating the matrix of content placeholders within the storyboard with said elements of viewable content and displaying said storyboard;
animating a content placeholder within the matrix of content placeholders;
removing each element of viewable content from the matrix of content placeholders so that the element is no longer displayed; and
repeating the cycle by returning to the tuning step until the termination of background mode.

2. A method as recited in claim 1, wherein said viewable content comprises photo content, image content, graphic content or video content.

3. A method as recited in claim 1, wherein tuning is performed by collecting viewable content from streaming content sources, or stored content, or network content.

4. A method as recited in claim 1, wherein tuning is performed according to a list of user favorites.

5. A method as recited in claim 1, wherein said storyboard comprises a two dimensional (x, y) matrix which is at least 2×2 in extent and up to 12×12 in extent; wherein the x and y array dimensions need not be equal.

6. A method as recited in claim 1, further comprising modifying the storyboard and said elements of viewable content in response to a selected theme for the storyboard.

7. A method as recited in claim 6, wherein each said theme comprises common color tints and patterns to which said elements of viewable content are modified.

8. A method as recited in claim 1:
wherein said storyboard is populated by freeze frame images; and
wherein said animating is performed by unfreezing the video so that it plays in that content placeholder.

9. A method as recited in claim 1:
wherein said storyboard is populated by still images; and
wherein said animating is performed on a portion of the still images by applying one or more animation effects to still images within that content placeholder.

10. A method as recited in claim 1:
wherein said storyboard is populated by freeze frame or still images; and
wherein said animating is performed on a portion of the still images by unfreezing the video of a freeze frame so that it plays in that content placeholder, or by applying one or more animation effects to still images within a still image placeholder.

11. A method as recited in claim 1:
wherein said elements of viewable content are sequentially animated and then removed from the matrix of content placeholders being displayed in the storyboard; and
performing a transition effect as each said element of viewable content is removed from the storyboard.

12. A method as recited in claim 11, wherein said transition effect concludes with a fade effect.

13. A method as recited in claim 1, wherein removing of each element of viewable content from the matrix content placeholders is performed in combination with tuning and populating the placeholder matrix so that a new element of viewable content replaces the prior viewable content within the placeholder matrix.

14. A method of generating a storyboard themed animated display background for a display-enabled device, comprising:
entering into a background mode of a display-enabled device;
tuning the input of the device to select viewable content;
said tuning is performed by collecting elements of viewable content from one or more sources of streaming content, stored content, and network content;
said viewable content is selected from one or more of the categories of content consisting of photo content, graphic content and video content;
generating a storyboard configured for receiving elements of said viewable content within a matrix of content placeholders;
populating the matrix of content placeholders within the storyboard with said elements of viewable content and displaying said storyboard;
modifying the storyboard and its viewable content elements in response to a selected theme which modifies tints, patterns, or combinations of tints and patterns;
animating a portion of the content placeholders within the matrix of content placeholders;
removing each element of viewable content from the matrix of content placeholders by performing a transition effect which terminates with removal from the storyboard of a specific element from the matrix of elements so that the element is no longer displayed; and
repeating the cycle by returning to the tuning step until the termination of background mode.

15. A method as recited in claim 14:
wherein said storyboard is populated by freeze frame images; and
wherein said animating is performed by unfreezing the video so that it plays in that content placeholder.

16. A method as recited in claim 14, wherein said animation effects are selected from the group of image effects consisting of lens flare and video texturing.

17. A method as recited in claim 14, wherein elements of viewable content are sequentially animated and then removed from the matrix of content placeholders being displayed in the storyboard.

18. A method as recited in claim 14, wherein said storyboard comprises a two dimensional (x, y) matrix which is at least 2×2 in extent and up to 12×12 in extent; wherein the x and y array dimensions need not be equal.

19. An apparatus for generating a storyboard themed animated display background for a display-enabled device, comprising:
a computer of a display-enabled device configured for processing sequences of images; and
programming executable on said computer for,
entering said display-enabled device into a background mode and starting a storyboard cycle,
tuning the input of said display-enabled device for selecting viewable content,
generating a storyboard configured for receiving elements of said viewable content within a matrix of content placeholders,
populating the matrix of content placeholders within the storyboard with said elements of viewable content and displaying said storyboard,
generating an animation for each element of viewable content in the matrix of content placeholders,
removing each element of viewable content from the matrix of content placeholders so that the element is no longer displayed, and
repeating the storyboard cycle by returning to the tuning step until the termination of background mode.

20. A computer-readable media containing a computer program executable on a computer of a display-enabled device configured for controlling the display of still and video images on an associated video display, comprising:
entering a display-enabled device into a background mode;
tuning the input of the device to select viewable content;
generating a storyboard configured for receiving elements of said viewable content within a matrix of content placeholders;
populating the matrix of content placeholders within the storyboard with said elements of viewable content and displaying said storyboard;
animating a portion of the content placeholders within the matrix of content placeholders;
removing each element of viewable content in the matrix of content placeholders so that the element is no longer displayed; and
repeating the cycle by returning to the tuning step until the termination of background mode.
